(19) United States
(12) Patent Application Publication
(10) Pub. No.: US 2016/0066311 A1
(43) Pub. Date: Mar. 3, 2016

(54) CELL UPDATE PROCEDURE ENHANCEMENTS

(71) Applicant: QUALCOMM Incorporated, San Diego, CA (US)

(72) Inventors: Sitaramanjaneyulu KANAMARLAPUDI, San Diego, CA (US); Nikhil Abhay Pai, San Diego, CA (US); Arvindhan Kumar, San Diego, CA (US); Liangchi Hsu, San Diego, CA (US); Chetan Gopalakrishnan Chakravarthy, San Diego, CA (US)

(21) Appl. No.: 14/671,762

(22) Filed: Mar. 27, 2015

Related U.S. Application Data
(60) Provisional application No. 62/042,009, filed on Aug. 26, 2014.

(51) Int. Cl. H04W 72/04

(52) U.S. Cl. CPC H04W 72/0413; H04W 84/042

(57) ABSTRACT

Methods and apparatuses for enhanced cell update procedures are presented. In an aspect, an example method may include determining that a first cell update trigger has occurred and generating a first cell update message based on determining that the first cell update trigger has occurred. In an additional aspect, the example method may include determining that a second cell update trigger has occurred subsequent to the first cell update trigger and generating a second cell update message based on determining that the second cell update trigger has occurred. Furthermore, the example method may include determining that at least a portion of the first cell update message is pending transmission at a time that the second cell update message is generated, discarding the first cell update message, and transmitting the second cell update message to a network entity.

### CROSS REFERENCE TO RELATED APPLICATIONS

The present application for patent claims priority to Provisional Application No. 62/042,009 entitled “CELLUPDATE PROCEDURE ENHANCEMENTS” filed Aug. 26, 2014, and assigned to the assignee hereof and hereby expressly incorporated by reference herein.

### BACKGROUND

The present disclosure relates to methods and apparatuses for enhanced cell update procedures in wireless networks and related devices.

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

For example, presently, there may be many different situations or conditions that may cause a user equipment (UE) to notify a network of a cell update associated with the particular situation or condition faced by the UE. The UE may perform this notification using cell update messages. When two or more of these situations or conditions occur in a relatively short period of time, the UE may end up sending several cell update messages to the network at about the same time. The network in turn may not be able to determine the appropriate action to take because of confusion caused by the distinct responses that are needed for the different cell update messages. For instance, in an example, a first cell update message with cause “Radio Link Failure” may be submitted to the Radio Link Control (RLC) layer. Before successful transmission of the first cell update message, the UE may reselect to another cell, which triggers generation of a second cell update message with a cause “CellReselection.” In this example, the possibility exists that both the first and second cell update messages are pending at an RLC uplink queue and may be transmitted to a network entity sequentially, or “back-to-back.” As a result of this sequential transmission of the cell update messages (e.g., in one or multiple sequential transfer time intervals (TTIs)), the network may be unable to determine which cell update message is to be processed, and may, in some cases, drop a call, cancel establishment of a connection, and/or terminate an ongoing connection. Furthermore, receiving the back-to-back cell update messages may unnecessarily interrupt the call establishment or an ongoing call.

Such an example is common when the UE is operating in an Enhanced Random Access Channel (RACH) configuration and where Enhanced Dedicated Channel (EDCH) resources are not available for full transmission of a complete cell update message. If there is not a sufficient resource grant on the channel, the complete cell update message may be pending in the uplink buffer until the expiry timer T302 expires. Also, if the grant is not sufficient to send the full message, a segmented portion of the cell update message may be pending in the RLC uplink queue when the expiry timer T302 expires. Again, this scenario may cause the network to terminate a connection or an ongoing connection establishment procedure.

Thus, a need exists for methods and apparatuses that can improve existing cell update procedures.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

For instance, the present disclosure describes an example method of managing a cell update procedure at a UE. In an aspect, the example method may include determining that a first cell update trigger has occurred and generating a first cell update message based on determining that the first cell update trigger has occurred. In an additional aspect, the example method may include determining that a second cell update trigger has occurred subsequent to the first cell update trigger and generating a second cell update message based on determining that the second cell update trigger has occurred. Furthermore, the example method may include determining that at least a portion of the first cell update message is pending transmission at a time that the second cell update message is generated, discarding the first cell update message, and transmitting the second cell update message to a network entity.

In an additional aspect, the present disclosure describes an example apparatus for managing a cell update procedure. The example apparatus may include means for determining that a first cell update trigger has occurred and means for generating a first cell update message based on determining that the first cell update trigger has occurred. Furthermore, the example apparatus may include means for determining that a second cell update trigger has occurred subsequent to the first cell update trigger and means for generating a second cell update message based on determining that the second cell update trigger has occurred. In addition, the example apparatus may include means for determining that at least a portion of the first cell update message is pending transmission at a time that the second cell update message is generated, means for discarding the first cell update message, and means for transmitting the second cell update message to a network entity.

Furthermore, the present disclosure describes an example non-transitory computer-readable medium storing computer-executable code. The computer-executable code may include code for determining that a first cell update trigger has occurred and code for generating a first cell update message based on determining that the first cell update trigger has occurred. In addition, the computer-executable code may include code for determining that a second cell update trigger has occurred subsequent to the first cell update trigger and code for generating a second cell update message based on determining that the second cell update trigger has occurred. In addition, the computer-executable code may include code for determining that at least a portion of the first cell update message is pending transmission at a time that the second cell update message is generated, code for discarding the first cell update message, and code for transmitting the second cell update message to a network entity.

Moreover, the present disclosure describes an example apparatus for managing a cell update procedure. In an aspect, the example apparatus may include a cell update trigger determining component configured to determine that a first cell update trigger has occurred and to determine that a second cell update trigger has occurred subsequent to the first cell update trigger. In addition, the example apparatus may include a cell update message generating component configured to generate a first cell update message based on determining that the first cell update trigger has occurred and to generate a second cell update message based on determining that the second cell update trigger has occurred. Furthermore, the example apparatus may include a cell update pending transmission determining component configured to determine that at least a portion of the first cell update message is pending transmission at a time that the second cell update message is generated. What is more, the example apparatus may include a cell update message discarding component configured to discard the first cell update message and a transmitter configured to transmit the second cell update message to a network entity.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram illustrating an example wireless communications system according to the present disclosure;

FIG. 2 is a block diagram illustrating an example cell update manager according to an example apparatus of the present disclosure;

FIG. 3 is a flow diagram comprising a plurality of functional blocks representing an example methodology of the present disclosure;

FIG. 4 is a diagram illustrating an example of a hardware implementation for an apparatus employing a processing system;

FIG. 5 is a block diagram conceptually illustrating an example of a telecommunications system;

FIG. 6 is a conceptual diagram illustrating an example of an access network;

FIG. 7 is a block diagram conceptually illustrating an example of a Node B in communication with a UE in a telecommunications system; and

FIG. 8 is a diagram illustrating an example of a radio protocol architecture for the user and control planes.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The present disclosure presents methods and apparatuses for enhancements in the manner in which a UE manages changes in situations or conditions that trigger a cell update such that the network may properly respond to rapidly changing situations or conditions. In an aspect, a first cell update message may be generated and placed in an uplink buffer for transmission to a network entity. While the transmission is pending transmission in the uplink queue, a second cell update message may be generated, for example, based on the same or a different reason (or “cause”) than that of the first cell update message. According to an aspect of the disclosure, if the first cell update message is still pending transmission in the uplink queue, the RRC may flush the layer 2 uplink buffers to discard at least a portion of the first cell update message. For example, where the first cell update message has been segmented and a subset of the segments are still pending transmission in the uplink queue, the RRC layer may pass an instruction to layer 2 to flush the pending segments from the uplink buffer. Once the first cell update message has been flushed from the uplink buffer, the RRC layer may pass second cell update message to layer 2 for placement in the uplink queue and the UE may transmit the second cell update message to the network entity thereafter.

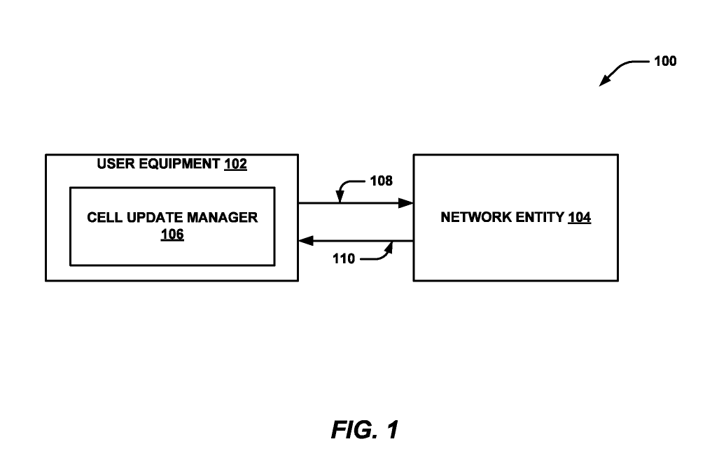

FIG. 1 is a schematic diagram illustrating a system 100 for improved management of cell update procedures, according to an example configuration. FIG. 1 includes an example network entity 104, which may communicate wirelessly with one or more UEs 102 over one or more wireless communication links. In an aspect, such a wireless communication link may comprise any over-the-air (OTA) communication link, including, but not limited to, one or more communication links operating according to specifications promulgated by 3GPP and/or 3GPP2, which may include first generation, second generation (2G), 3G, 4G, etc. wireless network architectures. Furthermore, though a single network entity 104 is shown in FIG. 1, additional network entities may exist in system 100 and may communicate with UE 102 contemporaneously with network entity 104.

In an aspect, UE 102 may be a mobile device, such as, but not limited to, a smartphone, cellular telephone, mobile phone, laptop computer, tablet computer, or other portable networked device. In addition, UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In general, UE 102 may be small and light enough to be considered portable and may be configured to communicate wirelessly via an over-the-air communication link using one or more OTA communication protocols described herein.

Furthermore, network entity 104 of FIG. 1 may include one or more of any type of network module, such as an access point, a macro cell, including a base station (BS), node B, eNodeB (eNB), a relay, a peer-to-peer device, an authentication, authorization and accounting (AAA) server, a mobile switching center (MSC), a radio network controller (RNC), or a low-power access point, such as a picocell, femtocell, microcell, etc. Additionally, network entity 104 may communicate with one or more other network entities of wireless and/or core networks.

Additionally, system 100 may include any network type, such as, but not limited to, wide-area networks (WAN), wireless networks (e.g. 802.11 or cellular network), the Public Switched Telephone Network (PSTN) network, ad hoc networks, personal area networks (e.g. Bluetooth®) or other combinations or permutations of network protocols and network types. Such network(s) may include a single local area network (LAN) or wide-area network (WAN), or combinations of LANs or WANs, such as the Internet.

Moreover, such network(s), which may include one or more network entities 104, may comprise a Wideband Code Division Multiple Access (W-CDMA) system, and may communicate with one or more UEs 102 according to this standard. As those skilled in the art will readily appreciate, various aspects described throughout this disclosure may be extended to other telecommunication systems, network architectures and communication standards. By way of example, various aspects may be extended to other Universal Mobile Telecommunications System (UMTS) systems such as Time Division Synchronous Code Division Multiple Access (TD-SCDMA), High Speed Downlink Packet Access (HSDPA), High Speed Uplink Packet Access (HSUPA), High Speed Packet Access Plus (HSPA+) and Time-Division CDMA (TD-CDMA). Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), Institute of Electrical and Electronics Engineers (IEEE) 802.11 (Wi-Fi), IEEE 802.16 (WiMAX®), IEEE 802.20, Ultra-Wideband (UWB), Bluetooth, and/or other suitable systems. The actual telecommunication standard, network architecture, and/or communication standard employed will depend on the specific application and the overall design constraints imposed on the system. The various devices coupled to the network(s) (e.g., UEs 102, network entity 104) may be coupled to a core network via one or more wired or wireless connections.

In addition, UE 102 may include a cell update manager 106, which may be configured to manage the cell update procedures of UE 102 according to aspects of the present disclosure.

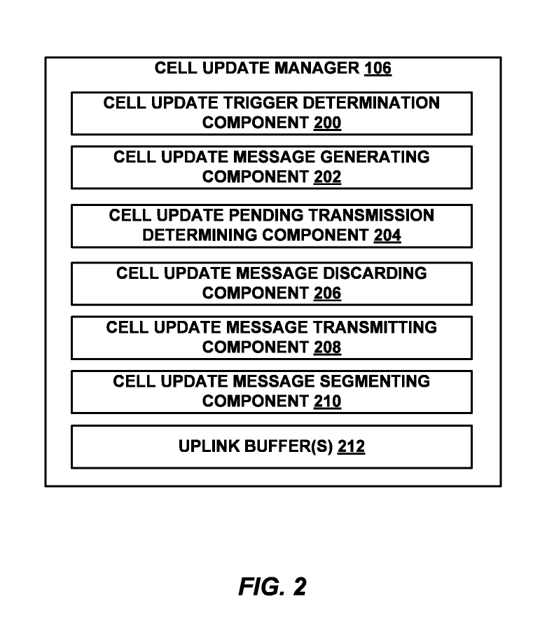

Turning to FIG. 2, an example cell update manager 106 (of FIG. 1, for example) is presented as comprising a plurality of individual components for carrying out the one or more methods or processes described herein. For example, in an aspect, cell update manager 106 may include a cell update trigger determination component 200, which may be configured to determine that a cell update trigger has occurred. In an aspect, a cell update trigger may comprise a condition that prompts a cell update procedure to begin. Such cell update triggers may include, but are not limited to, one or more triggers, or “causes,” outlined in 3GPP Specification Publication TS 25.331, Radio Resource Control (RRC) Protocol Specification (hereinafter “3GPP TS 25.331” and hereby incorporated by reference in its entirety) in at least subclause 8.3.1.1. These triggers or causes may include, but are not limited to, cell reselection, periodic cell update, uplink data transmission, paging response, reentering service area, radio link failure, RLC unrecoverable error, Multimedia Broadcast Multicast Service (MBMS) reception, MBMS Point-to-Point (PTP) radio bearer request, etc.

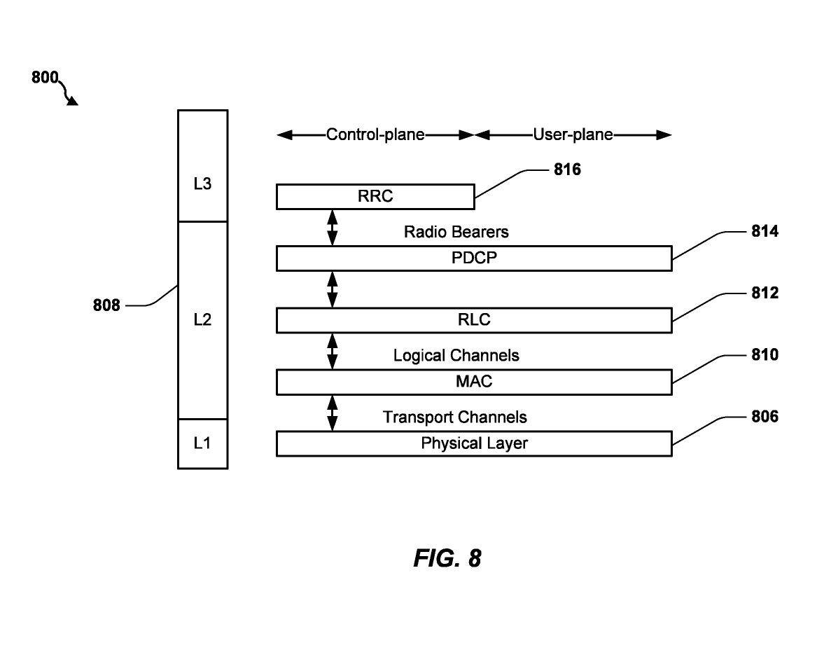

In addition, cell update manager 106 may include a cell update message generating component 202, which may be configured to generate one or more cell update messages based on the cell update trigger determination component 200 determining that one or more corresponding cell update triggers have occurred. For instance, such cell update messages may include a first cell update message, second cell update message, or the like. In addition, for purposes of the present disclosure, the cell update messages may include one or more CellUpdate messages as disclosed in 3GPP TS 25.331 (published by 3GPP and incorporated herein by reference). In an aspect, the cell update message generating component 202 may be configured to perform one or more functions associated with a Radio Resource Control (RRC), or layer 3, of a wireless communication protocol stack (see FIG. 8). For instance, layer 3 may responsible for detecting a cell update trigger and for generating the cell update message based on the cell update trigger. As such, cell update trigger determination component 200 and cell update message generating component 202 may be associated with layer 3 and perform one or more functions for which layer 3 is responsible.

Additionally, the cell update message generating component 202 may be configured to send the cell update messages (e.g., a first cell update message, second cell update message, or any other cell update message) for storage in one or more layer 2 uplink buffers. For instance, cell update message generating component 202 may be configured to send a first cell update message for storage in one or more layer 2 uplink buffers, wherein the first cell update message is subsequently discarded by flushing the one or more layer 2 uplink buffers. In addition, cell update message generating component 202 may be configured to send a second cell update message for storage in the one or more layer 2 uplink buffers after the one or more layer 2 uplink buffers are flushed. Moreover, for purposes of the present disclosure, the terms “discard” and “flush” may include erasing or otherwise clearing all or a portion of the stored contents of any memory, queue, buffer, or information storage element.

Furthermore, cell update manager 106 may include a cell update pending transmission determining component 204, which may be configured to determine that at least a portion of a cell update message is pending transmission, for example, at a time that the second cell update message is generated. In some examples, where a cell update message is segmented into multiple service data units (SDUs) or packet data units (PDUs) before transmission to a network entity, cell update pending transmission determining component 204 may be configured to determine that at least one bit, SDU, or PDU of the cell update message is pending transmission and/or is queued in an uplink buffer 212, which may be associated with layer 2 (e.g., the RLC layer). In an aspect, the cell update pending transmission determining component 204 may be configured to perform one or more functions associated with an RLC layer, or layer 2, of a wireless communication protocol stack (see FIG. 8). For instance, cell update pending transmission determining component 204 may be configured to receive a query from layer 3 (e.g., the RRC layer), the query requesting (i.e., implicitly or explicitly) a query response indicating whether a cell update message or portion thereof is pending transmission in the uplink buffer 212. Furthermore, based on receiving the query and determining whether such a cell update message is pending transmission, the cell update pending transmission determining component 204 may generate and send a query response message (i.e., answer) to the query to layer 3. For instance, where the cell update pending transmission determining component 204 determines that a cell update message or portion thereof is pending transmission, the cell update pending transmission determining component 204 may generate and send a message to layer 3 indicating that the cell update message (or portion thereof) is pending transmission in the uplink buffer of layer 2.

Additionally, cell update manager 106 may include a cell update message discarding component 206, which may be configured to discard (or “flush”) at least a portion of one or more cell update messages from uplink buffers 212. In an aspect, the uplink buffers 212 may include memory and may comprise one or more uplink buffers associated with layer 2 processes (e.g., layer 2 uplink buffers). Likewise, cell update message discarding component 206 may be configured to perform one or more functions associated with layer 2, such as the aforementioned discarding of one or more cell update messages (or a portion thereof) from uplink buffers 212) In other words, cell update message discarding component 206 may be associated with layer 2. Furthermore, cell update manager 106 may be configured to flush (e.g., partially or fully erase or remove the stored contents of) the uplink buffers 212 based on receiving a command or instruction to do so from layer 3 (e.g., the RRC layer) and/or a component associated with layer 3.

In addition, cell update manager 106 may include a cell update message transmitting component 208, which may be configured to transmit one or more cell update messages to one or more network entities 104. In some examples, cell update message transmitting component 208 may comprise a transmitter, transceiver, related circuitry, or any other apparatus or component configured to transmit wireless messages. Furthermore, cell update manager 106 may include a cell update message segmenting component 210, which may be configured to divide or fragment a cell update message into smaller units for transmission over a wireless network, where those smaller units or segments can be later reassembled to reconstruct the cell update message. As introduced above, such segments may comprise one or more SDUs or PDUs that are placed in uplink buffers 212 for transmission to a network entity.

Through the exemplary components illustrated in FIG. 2 are presented in reference to cell update manager 106 of FIGS. 1 and 2, they are not exclusive. Instead, cell update manager 106 may include additional or alternative components configured to perform aspects of the present disclosure and the claims below.

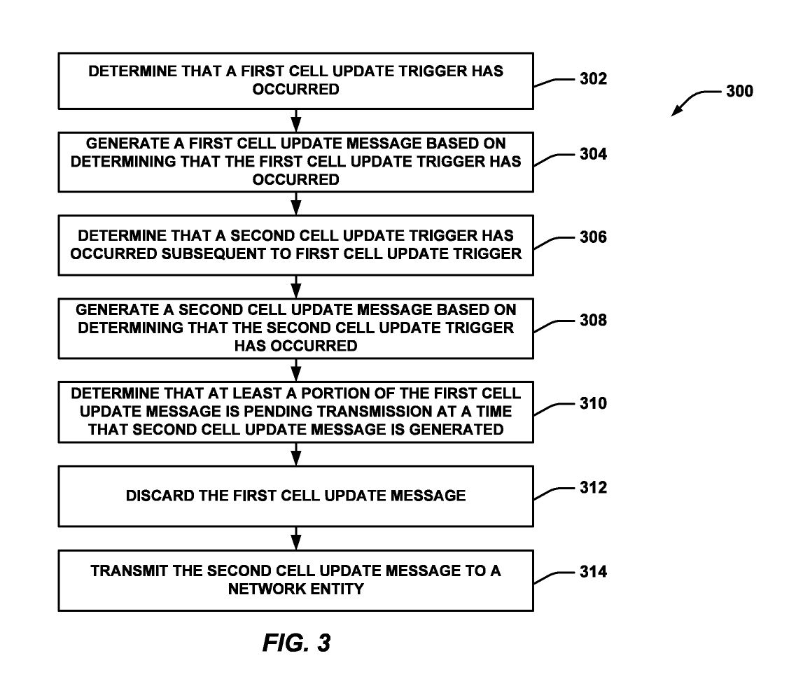

FIG. 3 presents an exemplary methodology 300 comprising a non-limiting set of steps represented as blocks that may be performed by one or more apparatuses described herein (e.g. a processing device or user equipment). In an aspect, methodology 300 may comprise a method of managing a cell update procedure at a UE, and may include, at block 302, determining that a first cell update trigger has occurred. In an aspect, block 302 may be performed by cell update trigger determination component 200 of FIG. 2. In addition, methodology 300 may include, at block 304, generating a first cell update message based on determining that the first cell update trigger has occurred. In an aspect, block 304 may be performed by cell update message generating component 202 of FIG. 2.

In addition, methodology 300 may include, at block 306, determining that a second cell update trigger has occurred, for example, subsequent to the first cell update trigger. In an aspect, block 306 may be performed by cell update trigger determination component 200 of FIG. 2. Furthermore, methodology 300 may include, at block 308, generating a second cell update message based on determining that the second cell update trigger has occurred. In an aspect, block 308 may be performed by cell update message generating component 202 of FIG. 2.

Additionally, methodology 300 may include, at block 310, determining that at least a portion of the first cell update message is pending transmission, for example, at a time that the second cell update message is generated. In an aspect, block 310 may be performed by cell update pending transmission determining component 204 of FIG. 2. In an aspect, determining that at least a portion of a cell update message is pending transmission may comprise determining that a Media Access Control (MAC) entity has not indicated a successful or unsuccessful transmission of the subject cell update message.

Furthermore, methodology 300 may include, at block 312, discarding the first cell update message. In an aspect, block 312 may be performed by cell update message discarding component 206 of FIG. 2. In some example, discarding a cell update message may include flushing one or more layer 2 uplink buffers. In addition, at block 314, methodology 300 may include transmitting the second cell update message to a network entity. In an aspect, block 314 may be performed by cell update message transmitting component 208 of FIG. 2.

In another aspect related to methodology 300, the first cell update message is segmented into multiple segments, and determining that at least a portion of the first cell update message is pending transmission comprises determining that at least one segment of the multiple of segments is pending transmission. For example, the cell update message segmenting component 210 segments the first cell update message and the cell update pending transmission determining component 204 determines that at least one segment of the first cell update message is pending transmission.

In a further aspect related to methodology 300, determining that at least the portion of the first cell update message is pending transmission at block 310 comprises determining that a Media Access Control (MAC) layer has not indicated to an upper layer a successful or unsuccessful transmission of the first cell update message to the network entity. In some aspects, cell update pending transmission determining component 204 determines that the MAC layer has not indicated to the upper layer a successful or unsuccessful transmission of the first cell update message to the network entity.

In an additional aspect related to methodology 300, determining that at least a portion of the first cell update message is pending transmission at block 310 may include querying, by a Radio Resource Control (RRC) layer, a Radio Link Control (RLC) layer as to whether the at least a portion of the first cell update message is pending transmission. In addition, block 310 may include receiving, at the RRC layer, a query response from the RLC layer, the query response indicating that the at least a portion of the first cell update message is pending transmission. In an additional aspect related to methodology 300, determining that at least a portion of the first cell update message is pending transmission at block 310 may include determining that the first cell update message is pending transmission in the RLC layer. In some examples, these aspects may be performed by cell update pending transmission determining component 204 of FIG. 2.

In an additional aspect related to methodology 300, discarding the first cell update message at block 312 may include the RRC layer sending a command to a RLC layer to flush one or more layer 2 uplink buffers that include the first cell update message. In an aspect, the RRC layer sending a command to a RLC layer to flush one or more layer 2 uplink buffers that include the first cell update message may be performed by cell update message discarding component 206.

In a further aspect, methodology 300 may further include passing the second cell update message from the RRC layer to the RLC layer after the first cell update message is discarded. Furthermore, one or both of the first cell update trigger and the second cell update trigger may comprise a cell reselection, a periodic cell update, an uplink data transmission, a paging response, a reentry into a cell service area, a radio link failure, a RLC unrecoverable error, a Multimedia Broadcast Mulitcast Service (MBMS) reception, or an MBMS point-to-point radio bearer request reception.

In an additional aspect, methodology 300 may include sending the first cell update message for storage in one or more layer 2 uplink buffers, wherein the first cell update message is discarded by flushing the one or more layer 2 uplink buffers. In addition, methodology 300 may include sending the second cell update message for storage in the one or more layer 2 uplink buffers after the one or more layer 2 uplink buffers are flushed.

It is to be understood that the specific order or hierarchy of various aspects in the methods disclosed is an illustration of exemplary processes. Based upon design preferences, it is understood that the specific order or hierarchy of various aspects in the methods may be rearranged. The accompanying method claims present elements of the various aspects in a sample order, and are not meant to be limited to the specific order or hierarchy presented unless specifically recited therein.

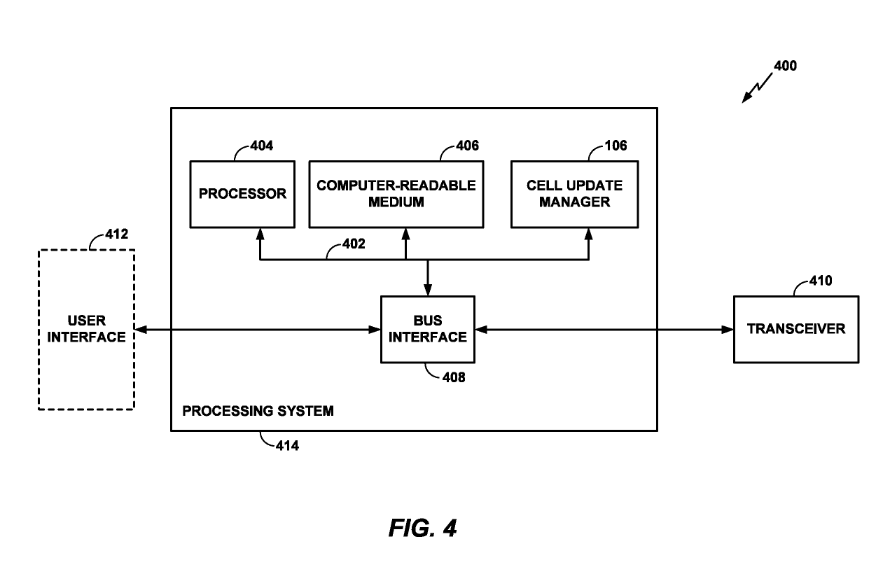

FIG. 4 is a conceptual diagram illustrating an example of a hardware implementation for an apparatus 400 employing a processing system 414. In some examples, the processing system 414 may comprise a UE or a component of a UE. In this example, the processing system 414 may be implemented with a bus architecture, represented generally by the bus 402. The bus 402 may include any number of interconnecting buses and bridges depending on the specific application of the processing system 414 and the overall design constraints. The bus 402 links together various circuits including one or more processors, represented generally by the processor 404, computer-readable media, represented generally by the computer-readable medium 406, and an cell update manager 106 (see FIG. 1), which may be configured to carry out one or more methods or procedures described herein. In an aspect, the cell update manager 106 and the components therein may comprise hardware, software, or a combination of hardware and software that may be configured to perform the functions, methodologies (e.g., methodology 300 of FIG. 3), or methods presented in the present disclosure.

The bus 402 may also link various other circuits such as timing sources, peripherals, voltage regulators, and power management circuits, which are well known in the art, and therefore, will not be described any further. A bus interface 408 provides an interface between the bus 402 and a transceiver 410. The transceiver 410 provides a means for communicating with various other apparatus over a transmission medium. Depending upon the nature of the apparatus, a user interface 412 (e.g., keypad, display, speaker, microphone, joystick) may also be provided.

The processor 404 is responsible for managing the bus 402 and general processing, including the execution of software stored on the computer-readable medium 406. The software, when executed by the processor 404, causes the processing system 414 to perform the various functions described infra for any particular apparatus. The computer-readable medium 406 may also be used for storing data that is manipulated by the processor 404 when executing software. In some aspects, at least a portion of the functions, methodologies, or methods associated with the cell update manager 106 may be performed or implemented by the processor 404 and/or the computer-readable medium 406.

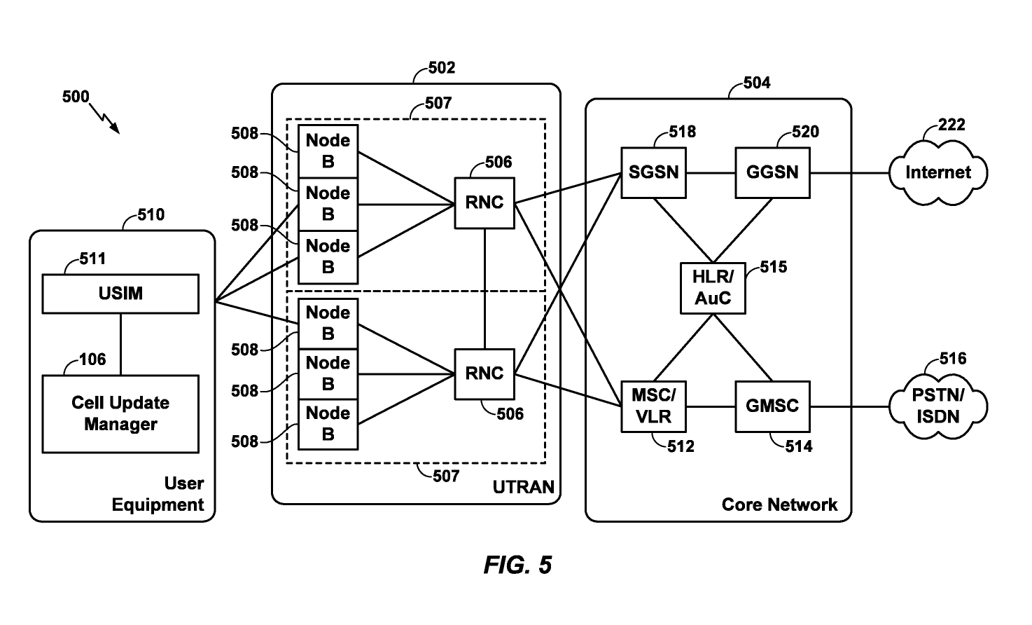

The various concepts presented throughout this disclosure may be implemented across a broad variety of telecommunication systems, network architectures, and communication standards. By way of example and without limitation, the aspects of the present disclosure illustrated in FIG. 5 are presented with reference to a UMTS system 500 employing a W-CDMA air interface. A UMTS network includes three interacting domains: a Core Network (CN) 504, a UMTS Terrestrial Radio Access Network (UTRAN) 502, and User Equipment (UE) 510. In this example, the UTRAN 502 provides various wireless services including telephony, video, data, messaging, broadcasts, and/or other services. The UTRAN 502 may include a plurality of Radio Network Subsystems (RNSs) such as an RNS 507, each controlled by a respective Radio Network Controller (RNC) such as an RNC 506. Here, the UTRAN 502 may include any number of RNCs 506 and RNSs 507 in addition to the RNCs 506 and RNSs 507 illustrated herein. The RNC 506 is an apparatus responsible for, among other things, assigning, reconfiguring and releasing radio resources within the RNS 507. The RNC 506 may be interconnected to other RNCs (not shown) in the UTRAN 502 through various types of interfaces such as a direct physical connection, a virtual network, or the like, using any suitable transport network.

Communication between a UE 510 and a Node B 508 may be considered as including a physical (PHY) layer and a medium access control (MAC) layer. Further, communication between a UE 510 and an RNC 506 by way of a respective Node B 508 may be considered as including a radio resource control (RRC) layer. In the instant specification, the PHY layer may be considered layer 1; the MAC layer may be considered layer 2; and the RRC layer may be considered layer 3. Information hereinbelow utilizes terminology introduced in Radio Resource Control (RRC) Protocol Specification, 3GPP TS 25.331 v9.1.0, incorporated herein by reference.

The geographic region covered by the SRNS 507 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 508 are shown in each SRNS 507; however, the SRNSs 507 may include any number of wireless Node Bs. The Node Bs 508 provide wireless access points to a core network (CN) 504 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. In a UMTS system, the UE 510 may further include a universal subscriber identity module (USIM) 511, which contains a user's subscription information to a network. In addition, UE 510 may include cell update manager 106, the composition and functionality of which are described throughout the present disclosure (see, e.g., FIGS. 1-3). For instance, cell update manager 106 may be configured to perform the functions and operations described above with respect to methodology 300 of FIG. 3. For illustrative purposes, one UE 510 is shown in communication with a number of the Node Bs 508. The downlink (DL), also called the forward link, refers to the communication link from a Node B 508 to a UE 510, and the uplink (UL), also called the reverse link, refers to the communication link from a UE 510 to a Node B 508.

The core network 504 interfaces with one or more access networks, such as the UTRAN 502. As shown, the core network 504 is a GSM core network. However, as those skilled in the art will recognize, the various concepts presented throughout this disclosure may be implemented in a RAN, or other suitable access network, to provide UEs with access to types of core networks other than GSM networks.

The core network 504 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the core network 504 supports circuit-switched services with a MSC 512 and a GMSC 514. In some applications, the GMSC 514 may be referred to as a media gateway (MGW). One or more RNCs, such as the RNC 506, may be connected to the MSC 512. The MSC 512 is an apparatus that controls call setup, call routing, and UE mobility functions. The MSC 512 also includes a visitor location register (VLR) that contains subscriber-related information for the duration that a UE is in the coverage area of the MSC 512. The GMSC 514 provides a gateway through the MSC 512 for the UE to access a circuit-switched network 516. The core network 504 includes a home location register (HLR) 515 containing subscriber data, such as the data reflecting the details of the services to which a particular user has subscribed. The HLR is also associated with an authentication center (AuC) that contains subscriber-specific authentication data. When a call is received for a particular UE, the GMSC 514 queries the HLR 515 to determine the UE's location and forwards the call to the particular MSC serving that location.

The core network 504 also supports packet-data services with a serving GPRS support node (SGSN) 518 and a gateway GPRS support node (GGSN) 520. GPRS, which stands for General Packet Radio Service, is designed to provide packet-data services at speeds higher than those available with standard circuit-switched data services. The GGSN 520 provides a connection for the UTRAN 502 to a packet-based network 522. The packet-based network 522 may be the Internet, a private data network, or some other suitable packet-based network. The primary function of the GGSN 520 is to provide the UEs 510 with packet-based network connectivity. Data packets may be transferred between the GGSN 520 and the UEs 510 through the SGSN 518, which performs primarily the same functions in the packet-based domain as the MSC 512 performs in the circuit-switched domain.

The UMTS air interface is a spread spectrum Direct-Sequence Code Division Multiple Access (DS-CDMA) system. The spread spectrum DS-CDMA spreads user data through multiplication by a sequence of pseudorandom bits called chips. The W-CDMA air interface for UMTS is based on such direct sequence spread spectrum technology and additionally calls for a frequency division duplexing (FDD). FDD uses a different carrier frequency for the uplink (UL) and downlink (DL) between a Node B 508 and a UE 510. Another air interface for UMTS that utilizes DS-CDMA, and uses time division duplexing, is the TD-SCDMA air interface. Those skilled in the art will recognize that although various examples described herein may refer to a WCDMA air interface, the underlying principles are equally applicable to a TD-SCDMA air interface.

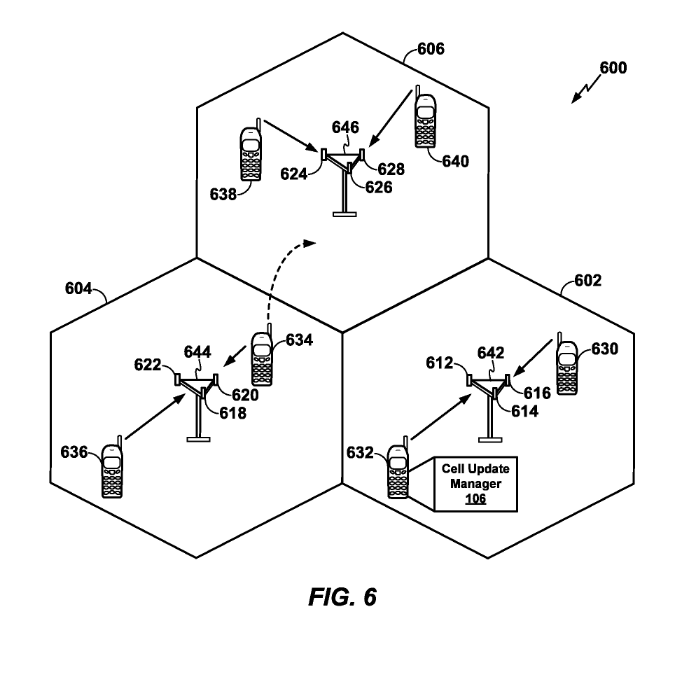

Referring to FIG. 6, an access network 600 in a UTRAN architecture is illustrated. The multiple access wireless communication system includes multiple cellular regions (cells), including cells 602, 604, and 606, each of which may include one or more sectors. The multiple sectors can be formed by groups of antennas with each antenna responsible for communication with UEs in a portion of the cell. For example, in cell 602, antenna groups 612, 614, and 616 may each correspond to a different sector. In cell 604, antenna groups 618, 620, and 622 each correspond to a different sector. In cell 606, antenna groups 624, 626, and 628 each correspond to a different sector. The cells 602, 604 and 606 may include several wireless communication devices, e.g., User Equipment or UEs, which may be in communication with one or more sectors of each cell 602, 604 or 606, and may represent UE 102 of FIG. 1 having an cell update manager 106 as described herein. For example, UEs 630 and 632 may be in communication with Node B 642, UEs 634 and 636 may be in communication with Node B 644, and UEs 638 and 640 can be in communication with Node B 646. Here, each Node B 642, 644, 646 is configured to provide an access point to a core network 504 (see FIG. 5) for all the UEs 630, 632, 634, 636, 638, 640 in the respective cells 602, 604, and 606. In addition, one or more of UEs 630, 632, 634, 636, 638, and/or 640 may include cell update manager 106, the composition and functionality of which are described throughout the present disclosure (see, e.g., FIGS. 1-3). For instance, cell update manager 106 may be configured to perform the functions and operations described above with respect to methodology 300 of FIG. 3.

As the UE 634 moves from the illustrated location in cell 604 into cell 606, a serving cell change (SCC) or handover may occur in which communication with the UE 634 transitions from the cell 604, which may be referred to as the source cell, to cell 606, which may be referred to as the target cell. Management of the handover procedure may take place at the UE 634, at the Node Bs corresponding to the respective cells, at a radio network controller 506 (see FIG. 5), or at another suitable node in the wireless network. For example, during a call with the source cell 604, or at any other time, the UE 634 may monitor various parameters of the source cell 604 as well as various parameters of neighboring cells such as cells 606 and 602. Further, depending on the quality of these parameters, the UE 634 may maintain communication with one or more of the neighboring cells. During this time, the UE 634 may maintain an Active Set, that is, a list of cells that the UE 634 is simultaneously connected to (i.e., the UTRA cells that are currently assigning a downlink dedicated physical channel DPCH or fractional downlink dedicated physical channel F-DPCH to the UE 634 may constitute the Active Set).

The modulation and multiple access scheme employed by the access network 600 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

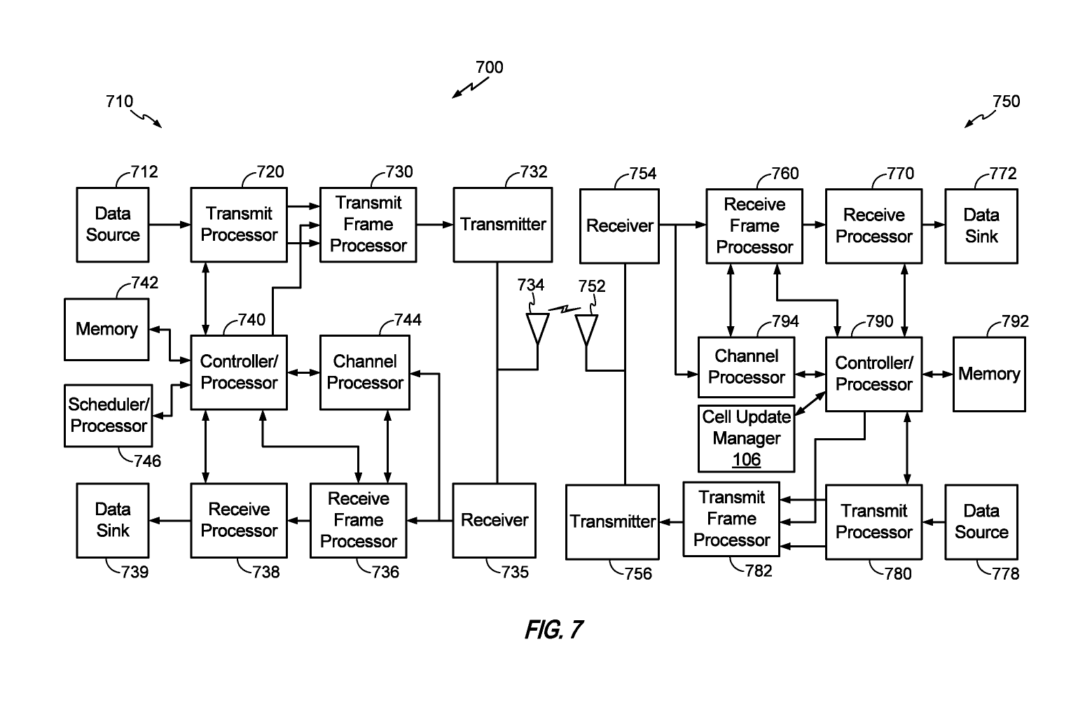

FIG. 7 is a block diagram of a Node B 710 in communication with a UE 750, where the Node B 710 may be the network entity 104 in FIG. 1, and the UE 750 may be the UE 102 in FIG. 1. In addition, UE 750 may include cell update manager 106, the composition and functionality of which are described throughout the present disclosure (see, e.g., FIGS. 1-3). For instance, cell update manager 106 may be configured to perform the functions and operations described above with respect to methodology 300 of FIG. 3.

In the downlink communication, a transmit processor 720 may receive data from a data source 712 and control signals from a controller/processor 740. The transmit processor 720 provides various signal processing functions for the data and control signals, as well as reference signals (e.g., pilot signals). For example, the transmit processor 720 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 744 may be used by a controller/processor 740 to determine the coding, modulation, spreading, and/or scrambling schemes for the transmit processor 720. These channel estimates may be derived from a reference signal transmitted by the UE 750 or from feedback from the UE 750. The symbols generated by the transmit processor 720 are provided to a transmit frame processor 730 to create a frame structure. The transmit frame processor 730 creates this frame structure by multiplexing the symbols with information from the controller/processor 740, resulting in a series of frames. The frames are then provided to a transmitter 732, which provides various signal conditioning functions including amplifying, filtering, and modulating the frames onto a carrier for downlink transmission over the wireless medium through antenna 734. The antenna 734 may include one or more antennas, for example, including beam steering bidirectional adaptive antenna arrays or other similar beam technologies.

At the UE 750, a receiver 754 receives the downlink transmission through an antenna 752 and processes the transmission to recover the information modulated onto the carrier. The information recovered by the receiver 754 is provided to a receive frame processor 760, which parses each frame, and provides information from the frames to a channel processor 794 and the data, control, and reference signals to a receive processor 770. The receive processor 770 then performs the inverse of the processing performed by the transmit processor 720 in the Node B 710. More specifically, the receive processor 770 descrambles and despreads the symbols, and then determines the most likely signal constellation points transmitted by the Node B 710 based on the modulation scheme. These soft decisions may be based on channel estimates computed by the channel processor 794. The soft decisions are then decoded and deinterleaved to recover the data, control, and reference signals. The CRC codes are then checked to determine whether the frames were successfully decoded. The data carried by the successfully decoded frames will then be provided to a data sink 772, which represents applications running in the UE 750 and/or various user interfaces (e.g., display). Control signals carried by successfully decoded frames will be provided to a controller/processor 790. When frames are unsuccessfully decoded by the receiver processor 770, the controller/processor 790 may also use an acknowledgement (ACK) and/or negative acknowledgement (NACK) protocol to support retransmission requests for those frames.

In the uplink, data from a data source 778 and control signals from the controller/processor 790 are provided to a transmit processor 780. The data source 778 may represent applications running in the UE 750 and various user interfaces (e.g., keyboard). Similar to the functionality described in connection with the downlink transmission by the Node B 710, the transmit processor 780 provides various signal processing functions including CRC codes, coding and interleaving to facilitate FEC, mapping to signal constellations, spreading with OVSFs, and scrambling to produce a series of symbols. Channel estimates, derived by the channel processor 794 from a reference signal transmitted by the Node B 710 or from feedback contained in the midamble transmitted by the Node B 710, may be used to select the appropriate coding, modulation, spreading, and/or scrambling schemes. The symbols produced by the transmit processor 780 will be provided to a transmit frame processor 782 to create a frame structure. The transmit frame processor 782 creates this frame structure by multiplexing the symbols with information from the controller/processor 790, resulting in a series of frames. The frames are then provided to a transmitter 756, which provides various signal conditioning functions including amplification, filtering, and modulating the frames onto a carrier for uplink transmission over the wireless medium through the antenna 752.

The uplink transmission is processed at the Node B 710 in a manner similar to that described in connection with the receiver function at the UE 750. A receiver 735 receives the uplink transmission through the antenna 734 and processes the transmission to recover the information modulated onto the carrier. The information recovered by the receiver 735 is provided to a receive frame processor 736, which parses each frame, and provides information from the frames to the channel processor 744 and the data, control, and reference signals to a receive processor 738. The receive processor 738 performs the inverse of the processing performed by the transmit processor 780 in the UE 750. The data and control signals carried by the successfully decoded frames may then be provided to a data sink 739 and the controller/processor, respectively. If some of the frames were unsuccessfully decoded by the receive processor, the controller/processor 740 may also use an acknowledgement (ACK) and/or negative acknowledgement (NACK) protocol to support retransmission requests for those frames.

The controller/processors 740 and 790 may be used to direct the operation at the Node B 710 and the UE 750, respectively. For example, the controller/processors 740 and 790 may provide various functions including timing, peripheral interfaces, voltage regulation, power management, and other control functions. The computer readable media of memories 742 and 792 may store data and software for the Node B 710 and the UE 750, respectively. A scheduler/processor 746 at the Node B 710 may be used to allocate resources to the UEs and schedule downlink and/or uplink transmissions for the UEs.

FIG. 8 is a diagram 800 illustrating an example of a radio protocol architecture for the user and control planes in UMTS, which may be utilized for wireless communication between UEs 102 and network entities 104 in the present disclosure. The radio protocol architecture for the UEs 102 and the network entities 104 is shown with three layers: layer 1 (L1), layer 2 (L2), and layer 3 (L3). In an aspect, although L1, L2, and L3 are represented generally as protocol layer abstractions in FIG. 8, each layer may have one or more physical components or computer-executable instructions that are configured to carry out the functions associated with the individual layers. As such, for purposes of the present disclosure, L1, L2, and/or L3 may not only refer to the individual layers themselves, but may also refer to the associated physical components or computer-executable instructions associated with each layer.

L1 is the lowest layer and implements various physical layer signal processing functions. The L1 layer will be referred to herein as the physical layer 806. In an aspect of the present disclosure, L1 may be responsible for the transmission of one or more cell update messages from a UE 102 to a network entity 104.

L2 808 is above the physical layer 806 and is responsible for the link between the UEs 102 and network entities 104 over the physical layer 806. In the user plane, the L2 layer 808 includes a media access control (MAC) layer (or sublayer) 810, a radio link control (RLC) layer (or sublayer) 812, and a packet data convergence protocol (PDCP) 814 sublayer, which are terminated at network entities 104 on the network side. In an aspect, the L2 and/or one or more sublayers therein (e.g., RLC layer 812) may have one or more associated uplink buffers that may be configured to store the contents of an uplink queue, which may contain one or more cell update messages that are queued for transmission to a network entity 104. According to an aspect of the present disclosure, L2 may receive the cell update messages from L3 (e.g., an RRC layer), which is responsible for generation of the cell update messages based on detection of one or more cell update triggers.

In addition, L2 may receive one or more queries from L3 as to whether a previously generated cell update message or portion thereof has been transmitted or remains pending in the uplink queue/uplink buffer. In response to such a query, L2 (or a component associated with L2) may determine whether a cell update message or portion thereof remains pending in the uplink queue/uplink buffer. Where L2 determines that at least a portion of a previously generated cell update message remains pending in the uplink queue/uplink buffer, L2 (or a component associated with L2) may generate and send a message to L3 to indicate that at least a portion of a cell update message remains pending in the uplink queue/uplink buffer. Alternatively, where L2 determines that no such cell update message is pending transmission, L2 may send a message to L3 to report this determination.

Furthermore, L2 may receive one or more messages or commands from L3 instructing L2 to discard (e.g., erase, remove, or flush) the contents of the uplink queue and/or the uplink buffer. Upon receiving such a message or command, L2 may fully or partially discard the contents of the uplink buffer.

Although not shown, the UE may have several upper layers above the L2 layer 808 including a network layer (e.g., IP layer) that is terminated at a PDN gateway on the network side, and an application layer that is terminated at the other end of the connection (e.g., far end UE, server, etc.).

The PDCP sublayer 814 provides multiplexing between different radio bearers and logical channels. The PDCP sublayer 814 also provides header compression for upper layer data packets to reduce radio transmission overhead, security by ciphering the data packets, and handover support for UEs 102 between network entities 104. The RLC sublayer 812 provides segmentation and reassembly of upper layer data packets, retransmission of lost data packets, and reordering of data packets to compensate for out-of-order reception due to hybrid automatic repeat request (HARQ). The MAC sublayer 810 provides multiplexing between logical and transport channels. The MAC sublayer 810 is also responsible for allocating the various radio resources (e.g., resource element blocks) in one cell among the UEs. The MAC sublayer 810 is also responsible for HARQ operations.

In the control plane, the radio protocol architecture for the UE 102 and network entities 104 is substantially the same for the physical layer 806 and the L2 layer 808 with the exception that there is no header compression function for the control plane. The control plane also includes a radio resource control (RRC) layer (or sublayer) 816 in L3. The RRC layer 816 is responsible for obtaining radio resources (i.e., radio bearers) and for configuring the lower layers using RRC signaling between the network entities 104 and the UE 102. In addition, in an aspect of the present disclosure, L3 (e.g., RRC layer 816) may be configured to determine that a cell update trigger has occurred and generate a cell update message based on determining that the cell update trigger has occurred. Furthermore, after the cell update message has been generated, L3 may query L2 as to whether a previously generated cell update message or a portion thereof remains in the uplink queue (i.e., is stored in the uplink buffer) pending transmission. Where L3 receives a response to the query from L2 that indicates that at least a portion of a previous cell update message remains pending in the uplink queue, L3 may generate a command instructing L2 to flush the uplink buffer and may pass the generated cell update message to L2 for transmission to a network entity. Alternatively, where L3 receives a response to the query from L2 that indicates no cell update messages (or a portion thereof) are pending transmission in the uplink queue, L3 may pass the cell update message to L2 for transmission without instructing L2 to flush the uplink buffer.

Several aspects of a telecommunications system have been presented with reference to an HSPA system. As those skilled in the art will readily appreciate, various aspects described throughout this disclosure may be extended to other telecommunication systems, network architectures and communication standards.

By way of example, various aspects may be extended to other UMTS systems such as W-CDMA, TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, or 35 U.S.C. §112(f), whichever is appropriate, unless the element is expressly recited using the phrase “means for” or, in the case of a method claim, the element is recited using the phrase “step for.”

We claim:

1. A method of managing a cell update procedure at a user equipment (UE), comprising:
determining that a first cell update trigger has occurred;
generating a first cell update message based on determining that the first cell update trigger has occurred;
determining that a second cell update trigger has occurred subsequent to the first cell update trigger;
generating a second cell update message based on determining that the second cell update trigger has occurred;
determining that at least a portion of the first cell update message is pending transmission at a time that the second cell update message is generated;
discarding the first cell update message; and
transmitting the second cell update message to a network entity.

2. The method of claim 1, further comprising segmenting the first cell update message into a plurality of segments, and wherein determining that at least a portion of the first cell update message is pending transmission comprises determining that at least one segment of the plurality of segments is pending transmission.

3. The method of claim 1, wherein determining that at least the portion of the first cell update message is pending transmission comprises determining that a Media Access Control (MAC) layer has not indicated to an upper layer a successful or unsuccessful transmission of the first cell update message to the network entity.

4. The method of claim 1, wherein determining that at least a portion of the first cell update message is pending transmission comprises:
querying, by a Radio Resource Control (RRC) layer, a Radio Link Control (RLC) layer as to whether the at least a portion of the first cell update message is pending transmission; and
receiving, at the RRC layer, a query response from the RLC layer, the query response indicating that the at least a portion of the first cell update message is pending transmission.

5. The method of claim 1, wherein determining that at least a portion of the first cell update message is pending transmission comprises determining that the first cell update message is pending transmission in a Radio Link Control (RLC) layer.

6. The method of claim 1, wherein discarding the first cell update message comprises a Radio Resource Control (RRC) layer sending a command to a Radio Link Control (RLC) layer to flush one or more layer 2 uplink buffers that include the first cell update message.

7. The method of claim 1, further comprising passing the second cell update message from a Radio Resource Control (RRC) layer to a Radio Link Control (RLC) layer after the first cell update message is discarded.

8. The method of claim 1, wherein one or both of the first cell update trigger and the second cell update trigger comprise a cell reselection, a periodic cell update, an uplink data transmission, a paging response, a reentry into a cell service area, a radio link failure, a Radio Link Control (RLC) unrecoverable error, a Multimedia Broadcast Mulitcast Service (MBMS) reception, or an MBMS point-to-point radio bearer request reception.

9. The method of claim 1, further comprising:
sending the first cell update message for storage in one or more layer 2 uplink buffers, wherein the first cell update message is discarded by flushing the one or more layer 2 uplink buffers; and
sending the second cell update message for storage in the one or more layer 2 uplink buffers after the one or more layer 2 uplink buffers are flushed.

10. An apparatus for managing a cell update procedure, comprising:
means for determining that a first cell update trigger has occurred;
means for generating a first cell update message based on determining that the first cell update trigger has occurred;
means for determining that a second cell update trigger has occurred subsequent to the first cell update trigger;
means for generating a second cell update message based on determining that the second cell update trigger has occurred;
means for determining that at least a portion of the first cell update message is pending transmission at a time that the second cell update message is generated;
means for discarding the first cell update message; and
means for transmitting the second cell update message to a network entity.

11. The apparatus of claim 10, further comprising means for segmenting the first cell update message into a plurality of segments, and wherein the means for determining that at least a portion of the first cell update message is pending transmission comprises means for determining that at least one segment of the plurality of segments is pending transmission.

12. The apparatus of claim 10, wherein the means for determining that at least the portion of the first cell update message is pending transmission comprises means for determining that a Media Access Control (MAC) layer has not indicated to an upper layer a successful or unsuccessful transmission of the first cell update message to the network entity.

13. The apparatus of claim 10, wherein the means for determining that at least a portion of the first cell update message is pending transmission comprises:
means for querying, by a Radio Resource Control (RRC) layer, a Radio Link Control (RLC) layer as to whether the at least a portion of the first cell update message is pending transmission; and
means for receiving, at the RRC layer, a query response from the RLC layer, the query response indicating that the at least a portion of the first cell update message is pending transmission.

14. The apparatus of claim 10, wherein the means for determining that at least a portion of the first cell update message is pending transmission comprises means for determining that the first cell update message is pending transmission in a Radio Link Control (RLC) layer.

15. The apparatus of claim 10, wherein the means for discarding the first cell update message comprises means for a Radio Resource Control (RRC) layer sending a command to a Radio Link Control (RLC) layer to flush one or more layer 2 uplink buffers that include the first cell update message.

16. The apparatus of claim 10, further comprising means for passing the second cell update message from a Radio Resource Control (RRC) layer to a Radio Link Control (RLC) layer after the first cell update message is discarded.

17. The apparatus of claim 10, wherein one or both of the first cell update trigger and the second cell update trigger comprise a cell reselection, a periodic cell update, an uplink data transmission, a paging response, a reentry into a cell service area, a radio link failure, a Radio Link Control (RLC) unrecoverable error, a Multimedia Broadcast Mulitcast Service (MBMS) reception, or an MBMS point-to-point radio bearer request reception.

18. The apparatus of claim 10, further comprising:
means for sending the first cell update message for storage in one or more layer 2 uplink buffers, wherein the first cell update message is discarded by flushing the one or more layer 2 uplink buffers; and
means for sending the second cell update message for storage in the one or more layer 2 uplink buffers after the one or more layer 2 uplink buffers are flushed.

19. A non-transitory computer-readable medium storing computer-executable code, the computer-executable code comprising:
code for determining that a first cell update trigger has occurred;
code for generating a first cell update message based on determining that the first cell update trigger has occurred;
code for determining that a second cell update trigger has occurred subsequent to the first cell update trigger;
code for generating a second cell update message based on determining that the second cell update trigger has occurred;
code for determining that at least a portion of the first cell update message is pending transmission at a time that the second cell update message is generated;
code for discarding the first cell update message; and
code for transmitting the second cell update message to a network entity.

20. The computer-readable medium of claim 19, wherein the computer-executable code further comprises code for segmenting the first cell update message into a plurality of segments, and wherein the code for determining that at least a portion of the first cell update message is pending transmission comprises code for determining that at least one segment of the plurality of segments is pending transmission.

21. The computer-readable medium of claim 19, wherein the code for determining that at least the portion of the first cell update message is pending transmission comprises code for determining that a Media Access Control (MAC) layer has not indicated to an upper layer a successful or unsuccessful transmission of the first cell update message to the network entity.

22. The computer-readable medium of claim 19, wherein the code for determining that at least a portion of the first cell update message is pending transmission comprises:
code for querying, by a Radio Resource Control (RRC) layer, a Radio Link Control (RLC) layer as to whether the at least a portion of the first cell update message is pending transmission; and
code for receiving, at the RRC layer, a query response from the RLC layer, the query response indicating that the at least a portion of the first cell update message is pending transmission.

23. The computer-readable medium of claim 19, wherein the code for determining that at least a portion of the first cell update message is pending transmission comprises code for determining that the first cell update message is pending transmission in a Radio Link Control (RLC) layer.

24. The computer-readable medium of claim 19, wherein the code for discarding the first cell update message comprises code for instructing a Radio Resource Control (RRC) layer to send a command to a Radio Link Control (RLC) layer to flush one or more layer 2 uplink buffers that include the first cell update message.

25. The computer-readable medium of claim 19, further comprising code for passing the second cell update message from a Radio Resource Control (RRC) layer to a Radio Link Control (RLC) layer after the first cell update message is discarded.

26. The computer-readable medium of claim 19, wherein one or both of the first cell update trigger and the second cell update trigger comprise a cell reselection, a periodic cell update, an uplink data transmission, a paging response, a reentry into a cell service area, a radio link failure, a Radio Link Control (RLC) unrecoverable error, a Multimedia Broadcast Mulitcast Service (MBMS) reception, or an MBMS point-to-point radio bearer request reception.

27. The computer-readable medium of claim 19, wherein the computer-executable code comprises:
code for sending the first cell update message for storage in one or more layer 2 uplink buffers, wherein the first cell update message is discarded by flushing the one or more layer 2 uplink buffers; and
code for sending the second cell update message for storage in the one or more layer 2 uplink buffers after the one or more layer 2 uplink buffers are flushed.

28. An apparatus for managing a cell update procedure, comprising:
a cell update trigger determining component configured to determine that a first cell update trigger has occurred and to determine that a second cell update trigger has occurred subsequent to the first cell update trigger;
a cell update message generating component configured to generate a first cell update message based on determining that the first cell update trigger has occurred and to generate a second cell update message based on determining that the second cell update trigger has occurred;
a cell update pending transmission determining component configured to determine that at least a portion of the first cell update message is pending transmission at a time that the second cell update message is generated;
a cell update message discarding component configured to discard the first cell update message; and
a transmitter configured to transmit the second cell update message to a network entity.

29. The apparatus of claim 28, further comprising a cell update message segmenting component configured to segment the first cell update message into a plurality of segments, and wherein the cell update pending transmission determining component is further configured to determine that at least one segment of the plurality of segments is pending transmission.

30. The apparatus of claim 28, wherein the cell update pending transmission determining component is further configured to determine that a Media Access Control (MAC) layer has not indicated to an upper layer a successful or unsuccessful transmission of the first cell update message to the network entity.
